(19) United States
(12) Patent Application Publication
(10) Pub. No.: US 2025/0350643 A1
(43) Pub. Date: Nov. 13, 2025

(54) AGENTLESS NETWORK MONITORING FOR NETWORK MANAGEMENT, INCLUDING THE RECOMMENDATION AND IMPLEMENTATION OF SECURITY POLICIES IN A MICROSEGMENTED NETWORK ENVIRONMENT

(71) Applicant: Arista Networks, Inc., Santa Clara, CA (US)

(72) Inventors: Keerthana PARTHASARATHY, Bangalore (IN); Chickayya G. NAIK, San Jose, CA (US); Alessandro BARBIERI, Santa Clara, CA (US); Padmini MISRA, Santa Clara, CA (US); Manoj Thekkedath NARAYANAN, San Jose, CA (US); Ashwin Deepak SWAMINATHAN, Santa Clara, CA (US)

(21) Appl. No.: 18/960,859

(22) Filed: Nov. 26, 2024

(30) Foreign Application Priority Data
May 7, 2024 (IN) 202441036062

(51) Int. Cl. H04L 9/40

(52) U.S. Cl. CPC H04L 63/20; H04L 63/104

(57) ABSTRACT

Embodiments of the systems and methods for network management disclosed adapted to allow the determination, implementation, and enforcement of group based security policies in a network are disclosed. These embodiments may utilize multi-tiered data collection and session correlation to determine group based sessions and utilize those group based sessions in the determination of group based security rules or group based security rule recommendations.

### RELATED APPLICATIONS

This application claims a benefit of priority under 35 U.S.C. § 119 to Indian Provisional Patent Application No. 202441036062 filed on May 7, 2024, entitled “Policy Generation and Recommendation in Network Environments,” the entire contents of which are incorporated herein by reference in their entirety for all purposes.

### COPYRIGHT NOTICE

A portion of the disclosure of this patent document contains material to which a claim for copyright may be made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

The disclosed embodiments relate to management of networks. In particular, disclosed embodiments relate to systems and methods for monitoring and controlling of traffic in a network environment. Even more particularly, embodiments relate to agentless monitoring of traffic in microsegmented network environments, correlation and summarization of session data based on such monitoring, and network security rule recommendations and implementation in these microsegmented networks.

### BACKGROUND

Network management is increasingly important in today's large, highly distributed, and complex, network environments. In particular, the implementation of security solutions with respect to network management has grown increasingly vital. Traditional network management employed a concept referred to as macrosegmentation. Macrosegmentation involves dividing a network into large segments or “macro” segments based on broad criteria, usually associated with the infrastructure or architecture of the network itself. Implementations of macrosegmentation are highly rigid in their divisions and rely on aspects of the network infrastructure to define the segments that are monitored and secured.

Microsegmentation solutions have thus emerged to combat these issues, managing networks and associated access controls based on divisions that may be defined without respect to traditional network boundaries. The rise of microsegmentation as an approach to network management, and network security in particular, has also been influenced by considerations such as the increasing adoption of zero tolerance architectures with respect to network implementations.

What is desired, therefore, are improved systems and methods for network management systems that facilitate microsegmentation in a network environment and specifically, systems and methods for improving the monitoring of traffic and implementation of security policies in such a microsegmented security environment.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIGS. 1A and 1B are diagrams of network environments depicting microsegments defined according to embodiments.

FIG. 2 is a block diagram of a network including one embodiment of a network management system.

FIGS. 3 and 4 are a block diagram of an embodiment of a traffic mapper and a flow diagram of an embodiment of a method for operation of a traffic mapper.

FIGS. 5 and 6 are a block diagram of an embodiment of a central network manager and a flow diagram of an embodiment of a method for operation of a central network manager.

FIGS. 7A-7D depict embodiments of interfaces according to embodiments.

FIGS. 8 and 9 are a block diagram of an embodiment of a network device and a flow diagram of an embodiment of a method for operation of a network device.

FIGS. 10 and 11 are diagrams depicting an example of mirroring packets to a traffic mapper based on a monitoring rule and exporting summarized sessions based on those mirrored packets according to an embodiment.

FIG. 12 is a diagram depicting an example of rule enforcement in a network device according to an embodiment.

### DETAILED DESCRIPTION

As discussed, network management is a broad and critical area that encompasses the administration, monitoring, optimization and securing of network infrastructures. It thus involves ensuring that network resources are used efficiently, performance is maintained, and security policies are enforced effectively. Traditionally, network management, and the implementation of security policies in association with such network management, employed a concept referred to as macrosegmentation. Macrosegmentation involves dividing a network into large segments or “macro” segments based on broad criteria, usually associated with the infrastructure or architecture of the network itself. In most cases, a macrosegmentation approach to network management involves implementing policies and rules at a firewall (or other network infrastructure devices) to control traffic between different (macro) segments of the network.

The use of macrosegmentation as a network management philosophy is, however, somewhat problematic in that it is highly rigid in its divisions and relies on aspects of the network infrastructure (such as network boundaries) to define the segments that are monitored and secured. Accordingly, traffic within those network boundaries (e.g., traffic originating from what may be hundreds of endpoints behind a firewall that never crosses that firewall) may not be monitored or secured. Additionally, the use of macrosegmentation fails to account for the desire to establish controls in these highly complex networks based on logical (or physical) segments of a network that may be unrelated to the network infrastructure itself, such as the identity of endpoints or applications in the network. Moreover, network infrastructure devices (e.g., firewalls or the like) may not be designed to cope with the volume and complexity of internal east-west traffic in a network entailed by the use of a macrosegmentation approach

Microsegmentation solutions have thus emerged to combat these issues, managing networks and associated access controls based on logical (or physical) divisions that may be defined without (or with) respect to traditional network boundaries. These microsegmentation solutions are often employed in conjunction with what is known as a zero trust architecture (ZTA). ZTA is a framework that applies controls to enforce explicit permission for traffic in a network environment. This framework is a departure from the traditional model that relied on implicit trust simply because traffic originated from a device on the “inside” of the network. Establishing microsegments (also known as microperimeters) dividing a network into smaller, controlled zones therefore facilitates the implementation of a zero trust approach to network security as the presence of microsegments limits the lateral movement of threats within the network, as access to these microsegments can be more tightly controlled and monitored. In particular, these microsegments serve to isolate network segments at a granular level, often down to the individual application or workload. This approach provides fine-grained control over traffic and access policies.

Utilizing microsegmentation for a zero trust approach to network security has its own set of challenges. Namely, network microsegmentation often results in inconsistent and fragmented architectures across networks (e.g., networks of different types such as campus or data-center networks), leading to gaps in security coverage and operational complexity. These gaps and complexity are exacerbated by the fact that in most cases the configuration of security policies in these microsegmented approaches is a highly manual process.

Moreover, continuous monitoring of network activity is an essential aspect of these zero trust approaches. This monitoring may involve analyzing network traffic in real-time to detect and respond to anomalies. Traditionally, such network monitoring is performed using agents installed on end devices and network infrastructure components. These agents are software applications or tools that are deployed on networked devices, including servers, workstations, routers, and switches. The primary functions of these agents are to collect data about network traffic, and to report this information back to a monitoring system.

There are a number of problems with agent based monitoring of network traffic. Agents consume computational resources on end devices on which they are deployed, which can impact their performance, especially on resource-constrained devices. This additional overhead may lead to degraded performance or increased operational costs. Furthermore, as networks grow in size and complexity, deploying and managing agents on a large number of devices becomes increasingly challenging. The maintenance of agents, including updates and configuration changes, can become cumbersome and error-prone. In a similar vein, the deployment and configuration of monitoring agents require significant manual effort and expertise. Incorrect configurations can lead to incomplete or inaccurate data collection, affecting the reliability of the monitoring system. As another consideration, the use of agents on end devices may itself introduce additional security risks, as the agents themselves may become targets for attacks, and the data transmitted by agents must be securely managed to prevent unauthorized access.

Of paramount importance is the fact that agents can only be deployed to endpoints (or devices) that are under the control of a network management solution (or entity controlling the network). For example, a campus network can be thought of as a proprietary local area network (LAN) (or set of interconnected LANs) serving a university, corporation, government agency, or other organization or entity. Oftentimes in these sorts of network environments users desire to join, or access, the campus network, and do so through a network device in the campus network. For example, users in a conference room or classroom may access a campus network through a wired or wireless interface provided by a network device in the network. In such scenarios, it will be virtually impossible to deploy agents on such endpoint devices. Thus, almost by its very nature, any agent based network security cannot be a zero trust environment and will, instead, be at most a partial trust environment.

Thus, to summarize, network microsegmentation is a crucial aspect of modern cybersecurity: it provides organizations with the ability to enhance their security posture by implementing fine-grained security policies based on microperimeters defined around logical entities (e.g., the identity of endpoints or applications) rather than on traditional network boundaries. A segmentation strategy based on microperimeters is the most effective solution to minimize the overall attack surface available to any endpoint. The rise of microsegmentation technologies is influenced by several key trends, such as the increasing adoption of the ZTA, which drives the requirements to segment networks into increasingly smaller trust zones (microperimeters) that are granularly identified and where only approved traffic is permitted.

What is desired, therefore, are improved systems and methods for network management systems that facilitate microsegmentation in a network environment and specifically, systems and methods for improving the monitoring of traffic and implementation of security policies in such a microsegmented security environment.

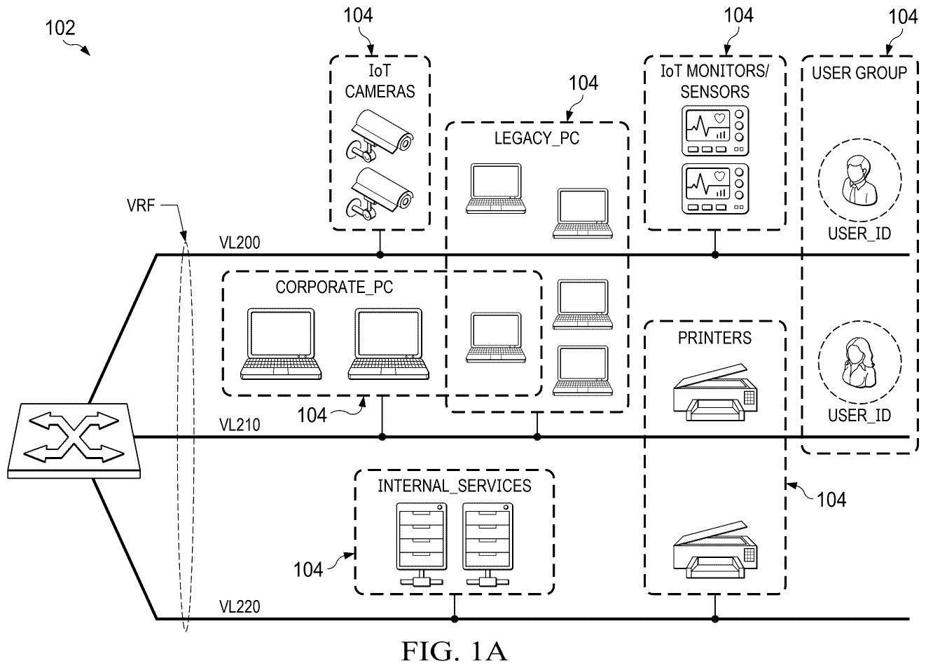

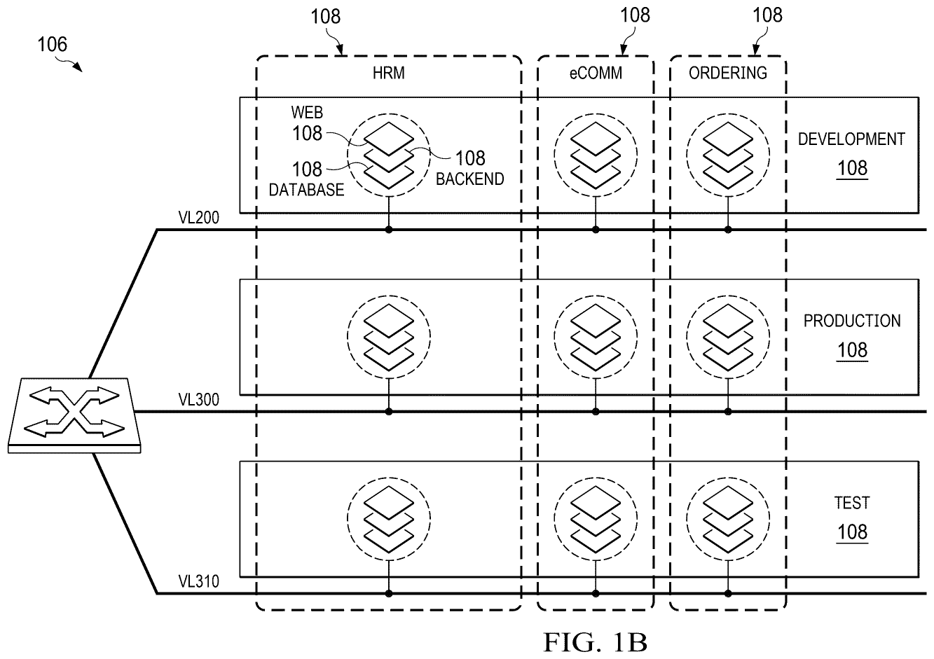

Some additional context of embodiments may be useful before proceeding further. Referring first to FIGS. 1A and 1B then, examples of two types of network environments (e.g., topologies or domains) with microsegments defined according to embodiments are depicted. It will be understood that for ease of depiction and description these figures represent (wired or wireless) networks with a single switch comprising multiple subnets (e.g., Virtual LANs (VLANs)) or a single Virtual Routing and Forwarding (VRF) domain, however, embodiments as described herein may be applied to almost any network environment, topology or domain without loss of generality.

Specifically, then, FIG. 1A depicts an example of a (e.g., portion of) a campus network 102. This example may comprise three VLANS (200, 210 and 220). Thus, while devices and users may exist on different VLANs it may be desired to define microsegments on this network that encompass logical or physical entities that may reside on different (or the same) devices or VLANs within that network. For example, it may be desired to define microsegments corresponding to IoT Cameras, Legacy PCs, IoT Monitors/Sensors, User Groups, Printers, Corporate PCs or Internal Services such that traffic between these various microsegments 104 may be monitored and controlled (or otherwise managed). It will be noticed that entities may belong to more than one microsegment 104. Thus, in a zero trust environment, ideally all traffic between entities in network 102 would be prevented unless it is explicitly permitted. Such permission may be given, for example, by defining security policies (e.g., one or more security rules) that permit traffic between microsegments (e.g., between entities comprising each of the microsegments).

Similarly, FIG. 1B depicts an example of a (e.g., portion of) a data center network 106. This example may comprise three VLANS (200, 300, 310). Thus, notice here that microsegments 108 may be defined relating to a deployment environment (e.g., Development, Production, Test), across VLANs in those environments (e.g., HRM, eComm or Ordering), and even based on individual applications or workloads (e.g., web, backend, database) across different endpoints and different portions of the network 106 (e.g., different VLANs). Again, notice that the logical or physical entities may belong to more than one microsegment 108.

As can be seen then, what is desired is to facilitate microsegmentation in these types of network environments by improving the monitoring of traffic and implementation of security policies in such a microsegmented network environment to enhance the overall security posture of these networks. To those ends, among others, attention is now directed to embodiments of the systems and methods for network management disclosed herein. Embodiments of these systems and methods for network management may be adapted to allow the determination, implementation, and enforcement of group based security policies between groups (or between groups and specific endpoints or between endpoints) in the same network (e.g., VLAN) or across multiple networks or portions of a network (e.g., a in a Virtual Routing and Forwarding network).

In particular, embodiments may allow microperimeters to be defined through the use of groups. These groups may associate a set of (i.e., one or more) identifiers of endpoints (e.g., hosts, devices, applications, networks, etc.) in a network with a group identifier (e.g., a group name). Thus, an identifier of an endpoint may include, for example, an IP address or a network (IP) prefix. These groups can be statically defined by users through interaction with an interface of a central network manager whereby administrator or other users may identify endpoints and map them to specific groups or may dynamically defined (and updated) based on context or identity information gleaned from data sources. Such dynamic group definition may be accomplished through an integration or importing of data from external network management databases to dynamically define and update groups, endpoints and mappings between the two at the central network manager.

During operation of the managed network then, traffic data associated with those groups may be determined by the network management system. Specifically, embodiments may employ multi-tiered traffic data collection and session mapping to gather traffic data and correlate sessions determined from the gathered traffic data with each other and with the defined groups. To implement a multi-tiered traffic data collection, in one embodiment network devices (e.g., network infrastructure devices such as switches or routers) may be configured with monitoring rules. These monitoring rules may be associated with a group or other definition of a type of traffic, including a definition for a source or destination of network traffic, a service or protocol (e.g., SMTP, TCP, HTTP, etc.) and specifying a monitoring action (it will be noted that protocol and service may be thought of similarly for purposes of this disclosure, however, a service may be understood in certain cases to be a higher level abstraction than a protocol and which may be a combination of the Layer 4 (transport layer) destination port(s) and protocol (e.g: SMTP, TCP, HTTP etc)). Traffic meeting a monitoring rule may be directed to a traffic mapper in the network. These traffic mappers may comprise standalone devices (e.g., “appliances”) within the network or may be deployed as a (e.g., distributed) application (e.g., as a virtual machine) within the network. For example, a single traffic mapper may be located in a spine of a leaf-spine Clos network or in each leaf of a Clos network, etc.

A monitoring rule may thus also define a location (e.g., device name, address, Uniform Resource Locator (URL), etc.) where to send monitored traffic. Accordingly, as traffic is being processed by the network device (e.g., in the course of normal operation of the network device), any traffic meeting the monitoring rule (e.g., associated with the group or traffic definition for the source or destination of such traffic and the service or protocol) may be mirrored to the traffic mapper (e.g., as specified in the monitoring rule).

As may be realized, a zero trust environment requires all traffic to be explicitly permitted. Thus, to create such zero trust policies that explicitly allow only the trusted traffic it may be desirable to have full visibility into the traffic sessions in a network. Thus, in one embodiment, the network management system may operate in an initial group rule definition phase whereby all traffic in the network being managed may be allowed and monitored. Thus, in this initial group rule definition phase network devices in the network may be configured with a monitoring rule specifying that all traffic (e.g., from any source to any destination for any protocol or service) may be mirrored from the network device to the traffic mapper (and may be permitted in the network). The traffic can thus be processed at the network device (e.g., forwarded, etc.) in accordance with normal operation of the network device while also being mirrored to the traffic mapper.

Accordingly, monitored (e.g., mirrored) traffic (e.g., packets) from network devices may be received at the traffic mappers in the network. A traffic map may then be generated from this received traffic at the traffic mapper. In particular, it may be desirable to determine a precise map of the communications among endpoints in the network such that group security rules that do not break existing applications and that explicitly permit desired (e.g., existing) traffic flows may be determined and recommended. The generated traffic map may thus be stateful, identifying observed (e.g., validated) sessions (bidirectional flows) occurring in the network (e.g., two flows that have been correlated as being associated with another and comprising traffic flowing in both directions). In other words, a session may comprise two flows: a first (or forward) flow and a corresponding second (or reverse) flow direction that has the IP address and (e.g., L4) ports swapped relative to the forward direction.

A traffic map may thus include a set of sessions (bidirectional flows) defined by a common tuple including a source endpoint (e.g., an identifier of an endpoint such as an IP address of an endpoint), a destination endpoint (e.g., an identifier of an endpoint such as an IP address of an endpoint) and an associated protocol or service (e.g., a layer 4, layer 7, or other service or protocol). Other data, such as a VRF may also be used to define a session.

There may also be session data associated with each session of the traffic map such as, for example, data counters specifying the size (e.g., amount) of traffic flowing in each direction between the two endpoints associated with the session (bidirectional flow) or an identification or the requestor or responder in the session.

In one embodiment, to generate this traffic map, as packets received from network devices are being processed by the traffic mapper, a source and destination (e.g., endpoints) can be determined for the packet being processed, along with a service or protocol associated with the packet or other data used to define a session (e.g., a VRF). As the same packet may be received from multiple network devices on the network configured with monitoring rules (e.g., switches) as the packet moves across the network, in certain cases the traffic mapper may also serve to de-duplicate these received packets (e.g., not process duplicative packets for purposes of generating a traffic map).

When a packet is processed, it can be determined if there is a session defined in the traffic map corresponding to the source, destination, service or protocol, etc. determined from the packet. In one embodiment, as the sessions of the traffic map may be bidirectional, it can be determined if there is any session in the traffic map where the source and destination of the session in the traffic map match either the source and destination obtained from the packet (or the destination and source obtained from the packet) and also match the service or protocol or other data as obtained from the packet. If there is a matching session in the traffic map, if there is data maintained for that session (e.g., the amount of data associated with traffic flowing between the two endpoints for that session) that data may be updated based on the packet. Otherwise, if there is no matching session for that packet in the traffic map, a session may be installed (e.g., created) in the traffic map using the source, destination, service or protocol, or other data obtained from the packet.

Accordingly, as the network is operating, the traffic mapper is dynamically updating this traffic map. After some time has elapsed (or at certain time intervals) the traffic mapper may export the traffic map including the summarized stateful sessions to a central network manager (e.g., one or more applications that may be deployed in a distributed manner, on a virtual or physical server, in the cloud, etc.). In one embodiment the summarization of sessions (e.g., from a reporting perspective) may include removing the (e.g., L4 source ports) that fall within a (e.g., configurable) ephemeral port range and aggregating associated (e.g., data) counters from such sessions. This traffic map can be exported, for example, as an Internet Protocol Flow Information Export (IPFIX) format or in another standardized format.

Again, as discussed above, the network management system may operate in an initial group rule definition phase whereby all traffic in the network being managed may be allowed and monitored, thus at the expiration of this initial group rule definition time period defined for the initial group rule definition phase an initial traffic map defining sessions occurring during normal operation of the network during that time period may be provided to the central network manager, such that initial rule recommendations may be made based on that initial traffic map.

During operation of the network, therefore, traffic may be continually received by the traffic mappers and these traffic mappers may continually determine (e.g., updated) traffic maps and provide these updated traffic maps to the central network manager. Based on these received traffic maps (e.g., from the one or more traffic mappers) central network manager, may determine a set of group based sessions. These group based sessions may be sessions defined by one or more (source) groups associated with the source for a session included in a traffic map or one or more (destination) groups associated with the destination for the session included in the traffic map. To determine a group session then, the central network manager may process each of the sessions of each traffic map to generate one or more corresponding group sessions, if needed.

Evaluating a session of the traffic map includes determining the source (e.g., the IP address) of that traffic map session and the destination (e.g., the IP address) of that traffic map session, along with a service or protocol of that traffic map session. Any groups associated with the determined source (e.g., source groups) and destination (e.g., destination groups) can then be determined from the group data associating group identifiers with endpoints on the network. It can then be determined if there are any group based sessions corresponding to that traffic map session already in the set of group based sessions. The presence of such a group based session can be determined by evaluating the group based sessions to determine if there are any group based sessions that have a source group and destination group corresponding to the determined source group for the traffic map session, the determined destination group for that traffic map session and have a service or protocol corresponding to the service or protocol determined from the traffic session.

If there is a matching group based session no further action may be taken (or data associated with that matching group based session may be updated). If, however, there is no matching group based session for that traffic map session, one or more group based sessions may be installed (e.g., created) in the set of group based session using the source group associated with the source of the traffic map session, the destination group associated with the destination of the traffic map session, and the service or protocol associated with the traffic map session being evaluated. Accordingly, by using groups associated with individual sources and destinations on the network to define these group based sessions, many different individual sessions in traffic maps that include sources and destinations belonging to the same groups may be consolidated into (in some cases) a single group based session. Expressed in another way each group based session may summarize sessions in the traffic map that have a source endpoint that is a member of the source group of the group based session and a destination endpoint that is member of the destination group of that group based session (e.g., and that also specify the same service or protocol as the group based session).

It will be noted that if there are multiple source groups or multiple destination groups associated with the source or destination as specified in the traffic map session, the group based session may include each of those determined source groups and destination groups as (respectively) source groups and destination groups for that group based session, or multiple group based sessions may be installed, where each of the group based sessions installed may comprise a different permutation of the multiple source groups and destination groups determined for the traffic map session under evaluation.

Based on the group based sessions, a number of group based security rules may be determined by the central network manager. These group based security rules may include a source group, a destination group, a protocol or service, or an action, where the source may be specified as a group (e.g., a group identifier associated with a set of endpoints), an address or prefix, or a value corresponding to any group and the destination may be specified as a group (e.g., a group identifier associated with a set of endpoints), an address or a prefix, or a value corresponding to any group. The service or protocol may be specifically defined (e.g., as a Layer 4 protocol or service) or specified as a value corresponding to any type of service or protocol. The action may be specified as, for example: forward or permit—indicating traffic meeting the rule is allowed to be bridged or routed to the destination, drop—indicating traffic meeting the rule is to be dropped, monitor—indicating traffic meeting the rule is allowed to be bridged or routed to the destination and a copy of the traffic should be sent to a configured traffic mapper, drop+monitor indicating traffic meeting the rule is to be dropped but a copy of the traffic should be sent to a configured traffic mapper, or redirect—indicating traffic meeting the rule meeting that rule will be redirected for a stateful or layer 7 inspection.

In one embodiment, for example, the central network manager may have a rule determination engine that may determine one or more group based security rule recommendations for a user and these group based security rule recommendations presented to a user (e.g., through a rule recommendation interface of the central network manager). These group based security rule recommendations may be based on the determined set of group based sessions representing actual or observed flows in the network. Thus, each group based security rule recommendation may comprise a group based security rule with a recommended action. This recommended action may, for example, be set to permit. Each of the group based security rules for a group based security rule recommendation can be determined based on a corresponding group based session, such that a group based security rule specifies the source as the source group of that corresponding group based session, the destination as the destination group of that corresponding group based session and the service or protocol as the service or protocol as that corresponding group based session.

In some embodiments, the rule determination engine may also take into account a set of categories when determining group based security rule recommendations to a user. As discussed, groups may comprise a collection of IP addresses or prefixes. Categories may thus be defined to include a set of groups. Accordingly, a user may select categories for which group based security rules are to be generated or recommended (e.g., through a rule recommendation interface of the central network manager).

Thus, in one embodiment, group based security rules (or recommendations) may be scoped or otherwise determined based on the categories specified by the user. Specifically, one or more categories associated with group based security rule recommendations may be determined (e.g., as selected by a user). When determining a group based security rule based on a group based session, the groups associated with the source and destination of the group based session can be evaluated to determine if they are included in the specified category. If so, all the groups that are both included in the specified category and associated with the source or destination of the group based session may be included in a group based security rule recommendation for that group based session. Alternatively, when generating a group based security rule recommendation for that group based session, specific IP addresses associated with traffic map sessions corresponding to that group based session may be utilized as the source or destination for the group based security rule recommendation such the user can evaluate that group based security rule recommendation to determine if that rule recommendation should be accepted (e.g., to determine if that traffic is expected or allowed).

In any event, group based security rule recommendations may be presented to a user and removed, evaluated, approved, or altered by a user (e.g., through a rule recommendation interface provided by the central network manager) to determine a set of group based security rules. In addition, a user may define their own group based security rules (e.g., using the rule recommendation interface or a rule definition interface). For example, as discussed above, the network management system may operate in an initial group rule definition phase whereby all traffic in the network being managed may be allowed and monitored and an initial traffic map defining sessions occurring during normal operation of the network during that time period may be provided to the central network manager. Based on that initial traffic map an initial set of group based session may be determined, and a set of initial group based security rule recommendations may be made to the user based on those initial set of group based sessions such that those initial group based security rule recommendations may be removed, evaluated, approved, or altered by a user (e.g., through the rule recommendation interface provided by the central network manager) to determine an (initial) set of group based security rules.

Once a set of group based security rules is determined, these security rules may be installed on the network devices of the network (e.g., by the central network manager) such that they can be implemented and enforced at the network devices as those network devices process network traffic. Each of these installed security rules may comprise a source group, a destination group, a protocol or service, and an action such that the action of the group based security rule can be performed in association with a packet matching that security rule. These group based security rules thus serve to explicitly permit certain traffic on network devices on which they are installed.

In one embodiment, to ensure a zero trust architecture (e.g., and to be able to update group based security rules) a zero trust (referred to also as a “last”) monitoring rule may also be installed at the network devices, where that last monitoring rule may specify any source (e.g., a packet specifying any source will meet this last monitoring rule), any destination (e.g., a packet specifying any destination will meet this last monitoring rule), any service or protocol (e.g., a packet using any (e.g., I4 or I7) protocol or service will meet this last monitoring rule) and an action of drop, or may specify an action of drop+monitor along with a location of a traffic mapper. Thus, this last rule specifies that all traffic (e.g., from any source to any destination for any protocol or service) will be dropped if it does not meet another security rule installed on the network device, including those that explicitly permit such traffic. The last rule may also ensure that zero trust architecture is in place but also, additionally, traffic may be mirrored from the network device to the traffic mapper such that it can be used to monitor traffic and update group based security rules.

In one embodiment, installing a group based security rule on a network device may include installing the group based security rule in specialized hardware or memory of the network device. For example, these group based security rules may be installed in a content addressable memory (CAM) such as a ternary CAM (TCAM) on the network device. In particular, these group based security rules may be installed as tag based rules where a tag is used to identify a source group and a destination group.

In these embodiments, a tag database may be stored at the network device. This tag database may associate a group (e.g., a group identifier for a group) with the set of IP addresses or prefixes corresponding to that group, and a corresponding tag. This tag database may be, for example, stored in relatively higher speed hardware or memory at the network device to accelerate access to such a database. The contents of such a tag database may be generated by the network device based on a set of group identifiers and set of IP addresses or prefixes associated with each group identifier (e.g., as received from the central network manager), or may be otherwise generated. When a network device installs a group based security rule into memory at the network device (e.g., into a TCAM at the network device), the group based security rule may be installed as a tag based rule by using the tags corresponding to the source groups and destination groups for that group based security rule as the source and destination values for the installed group based security rule in the memory.

Thus, when a packet is received at the network device, the source IP and destination IP address (or prefix) associated with the received packet may be determined along with the service or protocol corresponding to the received packet. The source IP determined from the packet can then be used to look up any associated groups with that source IP in the tag database and the corresponding tags for each of those groups determined. Similarly, the destination IP determined from the packet can be used to look up any associated groups with that destination IP in the tag database and the corresponding tags for each of those groups determined. The tags for the source groups and the tags for the destination groups can then be used (e.g., along with the service or protocol) to perform a match for installed tag based group security rules. Such a match may, for example, comprise a tag based lookup in a TCAM in which the group based security rules are installed. In this manner, these group based security rules may be matched and applied substantially in real-time (e.g., as wire speed) as the network device processes network traffic.

As can be seen then, embodiments as disclosed may have a number of advantages. One such advantage is the implementation of microperimeters for zero trust security using a consistent architecture across multiple types of networks (campus, branch, data center) predicated on an implementation that may be substantially common across all network infrastructure (e.g., switching) platforms or management platform. Moreover, embodiments of such a microperimeter implementation may be both network and endpoint agnostic: embodiments may have no dependency on any network data plane or control plane protocols, and at the same time may not require any software agents on the endpoints. Accordingly, such embodiments may also provide a unified framework for micro, as well as macro, segmentation policies enabling security rules to be built around microperimeter definitions (groups) as well as traditional network objects (subnets, VRFs), with the ability to enforce policies (e.g., at wire speed) in the network or redirect traffic to any traditional security gateways.

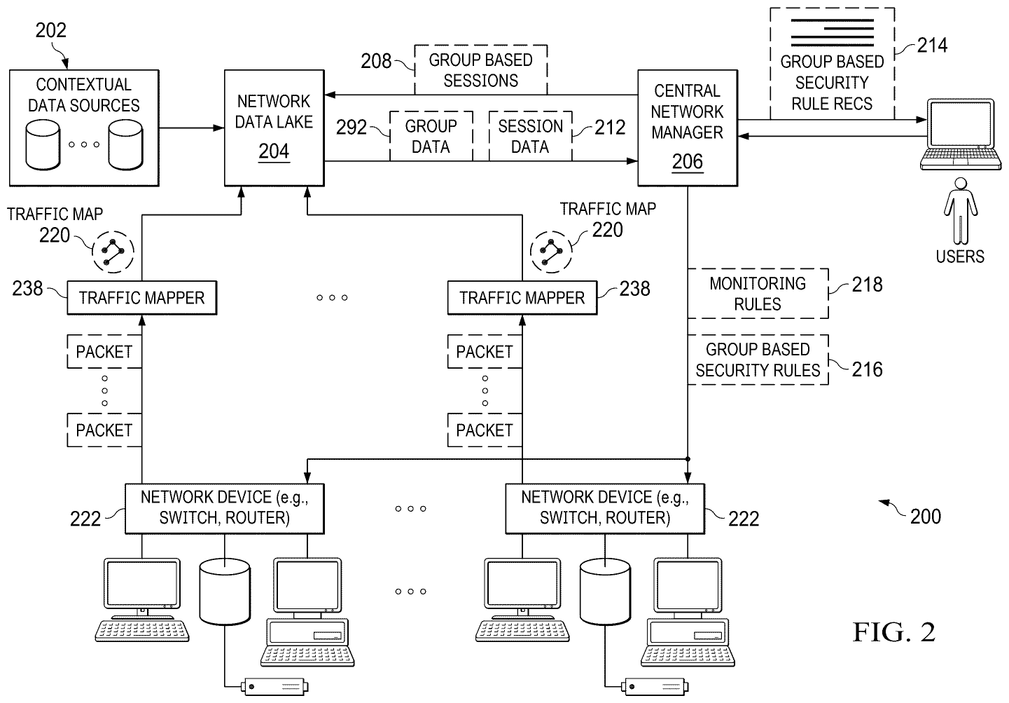

Turning now to FIG. 2, a network including one embodiment of a network management system adapted to perform agentless packet monitoring across the network to implement group based security rules is depicted. Network 200 may include a number of network devices 222 (e.g., switches, routers, etc.) implementing the infrastructure of the network 200. Thus, network devices 222 may be connected (directly or indirectly) to a number of endpoint devices, and process (e.g., forward) traffic (packets) in network 200.

Network management systems may include a central network manager 206 which may be one or more applications that may be deployed in a distributed manner, on a virtual or physical server, in the cloud, etc.). Central manager 206 may allow microperimeters to be defined through the use of groups. These groups can be statically defined by users through interaction with an interface of a central network manager 206 or these groups may be dynamically defined (and updated) based on context or identity information gleaned from contextual data sources 202.

Such dynamic group definition may be accomplished through an integration or importing of data from external network management databases to dynamically define and update groups, endpoints and mappings between the two at the central network manager. For example, Network Access Control (NAC) is a common security function that regulates and manages access to networks by devices and users, ensuring compliance with security policies and protecting against unauthorized access and potential threats. Thus, NAC systems may serve as a contextual data source 202 for defining groups. Other contextual data sources can include, for example, identity management systems, threat assessment systems, network modeling or management systems, configuration management database, virtualization platforms, or almost any other data source that may group or relate endpoints (e.g., or IP addresses or prefixes) associated with a network. This group data (e.g., group definitions) may be stored in a network data lake 204 which may, for example, be a distributed data store or a data store implemented in a cloud computing environment.

Central network manager 206 can configure network device 222 with monitoring rules 218. These monitoring rules may be associated with a group or other definition of a type of traffic, including a definition for a source or destination of network traffic, a service or protocol (e.g., SMTP, TCP, HTTP, etc.) and specifying a monitoring action. Monitoring rule 218 may thus also define a location (e.g., device name, address, Uniform Resource Locator (URL), etc.) of a traffic mapper 238 to which traffic meeting that monitoring rule should be sent. Traffic mappers 238 may comprise standalone devices (e.g., “appliances”) within the network or may be deployed as a (e.g., distributed) application (e.g., as a virtual machine) within the network. In one embodiment, the network management system may operate in an initial group rule definition phase whereby all traffic in network 200 may be allowed and monitored. Thus, in this initial group rule definition phase network devices 222 in the network 200 may be configured with a monitoring rule 218 specifying that all traffic (e.g., from any source to any destination for any protocol or service) may be mirrored from the network device to the traffic mapper. Accordingly, as traffic is being processed by the network device 222 packets meeting those monitoring rules may be mirrored to traffic mapper 238 (e.g., as specified in the monitoring rule).

Monitored (e.g., mirrored) traffic (e.g., packets) from network devices 222 is thus received at traffic mappers 238 in the network 200. Traffic mapper 238 generates traffic map 220 corresponding to those received packets and stores traffic map 220 in network data lake 204. The generated traffic map 220 may identify sessions (bidirectional flows) occurring in the network 200 (e.g., two flows that have been correlated as being associated with another and comprising traffic flowing in both directions). Each session may be defined in traffic map 220 by a common tuple (set of data) including a source address (an IP address of an endpoint), a destination address (e.g., an IP address or an endpoint) and an associated protocol or service (e.g., a layer 4, layer 7, or other service or protocol).

Central network manager 206 may use this session data 212 (e.g., included in traffic maps 220) and the group data 210 from network data lake 204 to determine group based security rules 216 for configuration of network devices 222. In particular, central network manager 206 may determine a set of group based sessions 208 defined by one or more (source) groups associated with the source for a session included in a traffic map 220 or one or more (destination) groups associated with the destination for the session included in a traffic map 220. By using groups associated with individual sources and destinations on the network as included in traffic map sessions to define group based sessions, many different individual sessions in traffic map that include sources and destinations belonging to the same groups may be consolidated into (in some cases) a single group based session.

Using these group based sessions then, central network manager 206 may determine a number of group based security rule recommendations 214 where each of those group based security rule recommendations may include a group based security rule having a source group (or IP address or prefix), a destination group (or IP address or prefix), a protocol or service and an action, For purposes of a group based security rule recommendations 214, the action may be a forward or permit action. These group based security rule recommendations 214 may be presented to a user such that the user can remove, evaluate, approve, or alter those recommendations 214 to define a set of group based security rules 216 through central network manager 206. Once the set of group based security rules 216 is determined, these security rules 216 may be installed on the network devices 222 of the network by central network manager 206 such that they can be implemented and enforced at the network devices 222 as those network devices 222 process network traffic from endpoints in the network 222.

In one embodiment, the network management system may operate in an initial group rule definition phase whereby all traffic in network 200 may be allowed and monitored. Thus, in this initial group rule definition phase network devices 222 in network 200 may be configured with monitoring rule 218 specifying that all traffic (e.g., from any source to any destination for any protocol or service) may be mirrored from network device 222 to traffic mapper 238 (and may be permitted in network 222). During this initial group rule definition phase traffic can thus be processed at network devices 222 (e.g., forwarded, etc.) in accordance with normal operation of network device 222 while also being mirrored to traffic mapper 238.

At the expiration of this initial group rule phase (e.g., at the expiration of an initial group rule definition time period defined for the initial group rule definition phase), initial traffic map 220 defining sessions occurring during normal operation of network 220 during that initial time period may be stored in network data lake 204. Based on that initial traffic map 220 an initial set of group based sessions may be determined, and a set of initial group based security rule recommendations 214 may be made to the user. Based on those initial group based security rule recommendations 214 an initial set of group based security rules 216 may be determined and installed on network devices 222. Additionally, a last monitoring rule 218 (e.g., to drop and monitor all traffic) may also be installed on network devices 222 to ensure a zero trust network environment. Based on this last monitoring rule 218 subsequent traffic in network 200 may be monitored, new traffic maps 220 created and group based security rules updated.

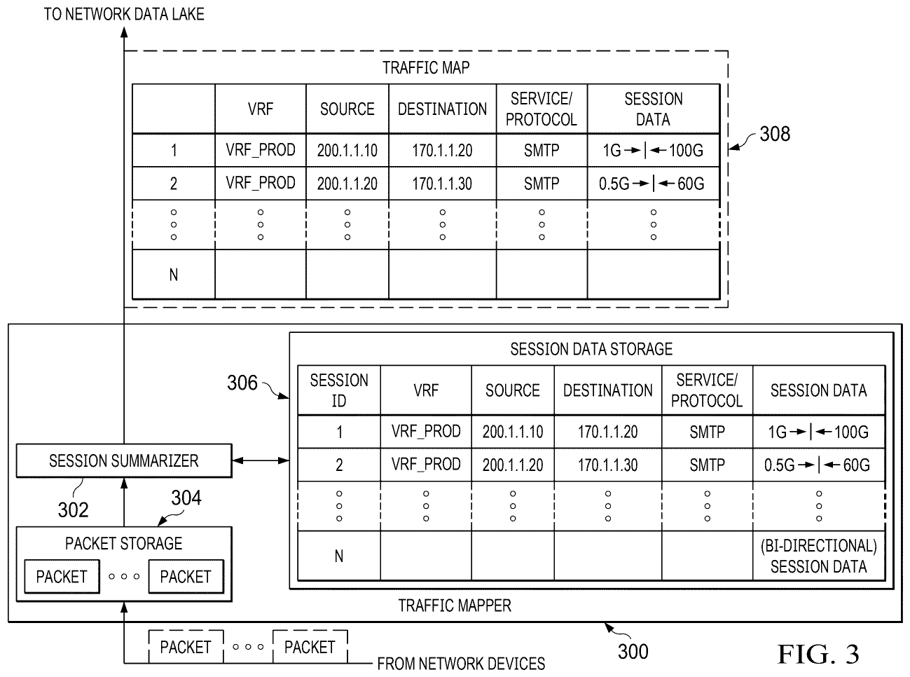

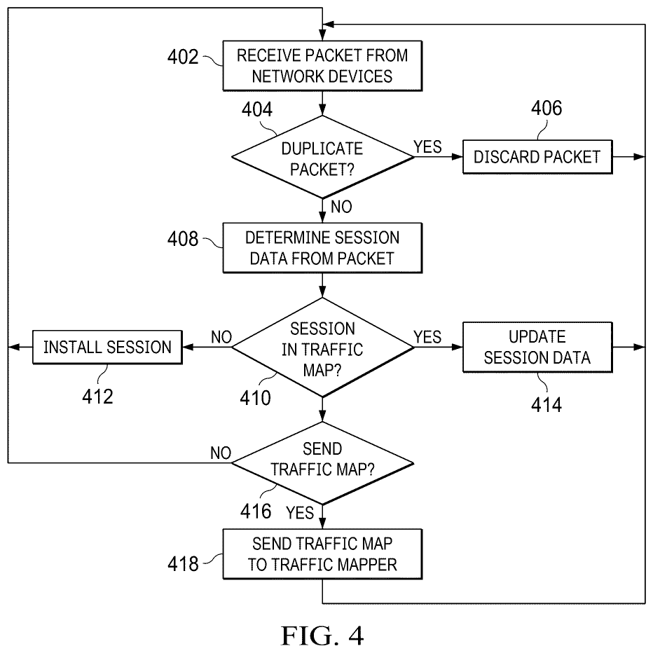

It may now be useful to describe particular embodiments of components of these types of network management systems in more detail. Referring then to FIGS. 3 and 4, one embodiment of a traffic mapper and an embodiment of an associated method for operation of a traffic mapper are depicted. Traffic mapper 300 may receive packets from network devices in a network (STEP 402) and store these received packets in packet storage 304. Session summarizer 302 may generate a traffic map 308 from these packets. The generated traffic map 308 may be stateful, identifying validated sessions (bidirectional flows) occurring in the network.

A traffic map 308 may thus include a set of sessions (bidirectional flows) where each session is defined by a set of data (referred to as a tuple) including a source address (an IP address of an endpoint), a destination address (e.g., an IP address or an endpoint) and an associated protocol or service (e.g., a layer 4 or other service or protocol). Other data, such as a VRF may also be used to define a session. There may also be session data associated with each session of the traffic map such as, for example, data counters specifying the size (e.g., amount) of traffic flowing in each direction between the two endpoints associated with the (bidirectional) session or an identification or the requestor or responder in the session.

In one embodiment, session summarizer 302 may generate traffic map 308 in session storage 306 by processing packets received from network devices. As the same packet may be received from multiple network devices on the network configured with monitoring rules (e.g., switches) as the packet moves across the network, in certain cases the traffic mapper may also serve to de-duplicate these received packets (e.g., not process duplicative packets for purposes of generating a traffic map). To de-duplicate these packets, when processing a received packet session summarizer 302 may determine if that packet is duplicative of a packet that has previously been processed (STEP 404) and discard that packet if it is (Y Branch of STEP 404, STEP 406).

If the packet is not duplicative of a previously processed packet (N Branch of STEP 404), session summarizer 302 may determine session data from the packet (STEP 408). In particular, a source and destination can be determined for the packet being processed, along with a service or protocol associated with the packet or other data used to define a session (e.g., a VRF). When a packet is processed, it can be determined if there is a session defined in the traffic map 308 corresponding to the source, destination, service or protocol, etc. determined from the packet (STEP 410). In one embodiment, as the sessions of the traffic map may be bidirectional, it can be determined if there is any session in the traffic map where the source and destination of the session in the traffic map match either the source and destination obtained from the packet (or the destination and source obtained from the packet) and also match the service or protocol or other data as obtained from the packet.

If there is a matching session in the traffic map 408 (Y Branch of STEP 410), session data (e.g., the amount of data associated with traffic flowing between the two endpoints for that session) for that session may be updated based on the packet (STEP 414) and the next packet is processed. Otherwise, if there is no matching session for that packet in the traffic map (N Branch of STEP 410), a session may be installed (e.g., created) in traffic map 308 using the source, destination, service or protocol, or other data obtained from the packet (STEP 412).

Accordingly, as the network is operating, traffic mapper 300 is dynamically updating this traffic map 308. At some point (e.g., after some time has elapsed, or at certain time intervals) session summarizer 302 may determine that traffic map 308 should be exported (e.g., sent, stored, or otherwise made available) to a central network manager (Y Branch of STEP 416). When this determination is made, session summarizer 302 may export traffic map 308 including the summarized stateful sessions to a central network manager (STEP 418). Exporting traffic map 308 may include, for example, storing it in a network data lake or other storage location associated with the central network location. This traffic map can be exported, for example, as an Internet Protocol Flow Information Export (IPFIX) format or in another standardized format. At this point a new traffic map may be created and processing of packets received from network devices resumed (STEP 402). If it is determined that traffic map 308 should not be exported (N Branch of STEP 416), a subsequent packet may be processed (STEP 402).

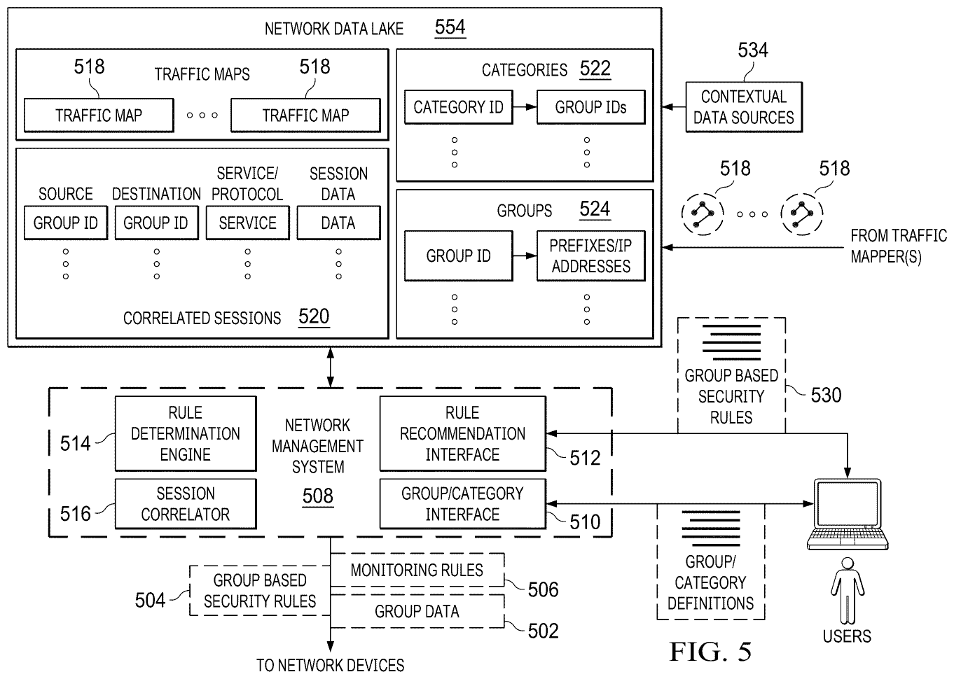

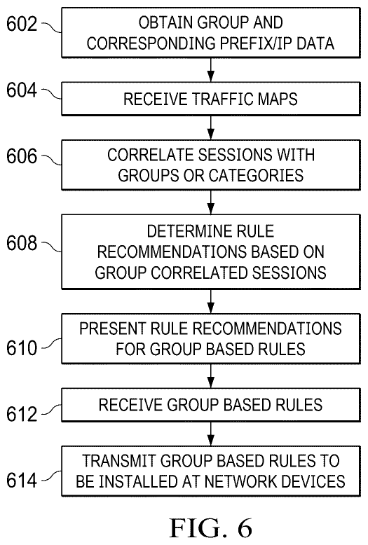

Looking now at FIGS. 5 and 6, one embodiment of a central network manager and an embodiment of an associated method for operation of a central network manager for network management according to group based security rules are depicted. Central network manager 508 may include (or otherwise access) network data lake 554, which may, for example, be a distributed data store or a data store implemented in a cloud computing environment.

Central network manager 508 may allow microperimeters to be defined through the use of groups 524, where the definition of such groups 524 may be stored in network data lake 554 (STEP 602). These groups 524 may associate a set of (i.e., one or more) identifiers of endpoints (e.g., hosts, devices, applications, networks, etc.) in a network with a group identifier (e.g., a group name). Thus, an identifier of an endpoint may include, for example, an IP address or a network (IP) prefix. Central network manager 508 may also maintain categories 522 in network data lake 554. A category 522 may include a set of groups 524.

These groups 524 and categories 522 can be statically defined by users through interaction with a (group/category) interface 510 of central network manager 508 whereby an administrator or other users may identify endpoints and map them to specific groups to define a group or define a category and map them to a set of groups. Groups 524 and categories 522 may also be dynamically defined (and updated) based on context or identity information gleaned from contextual data sources 534. For example, such dynamic group definition may be accomplished through an integration or importing of data from external network management databases to dynamically define and update groups, endpoints and mappings between the two at the central network manager 508 such as NAC databases, identity management systems, threat assessment systems, network modeling or management systems, configuration management database, virtualization platforms, or almost any other data source that may group or relate endpoints in a network.

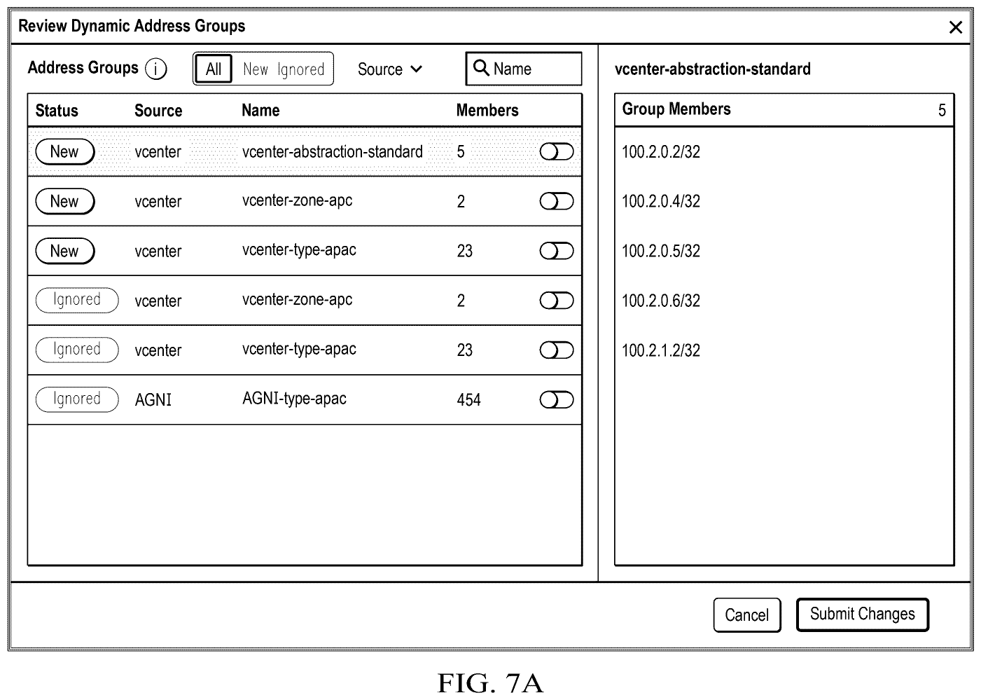

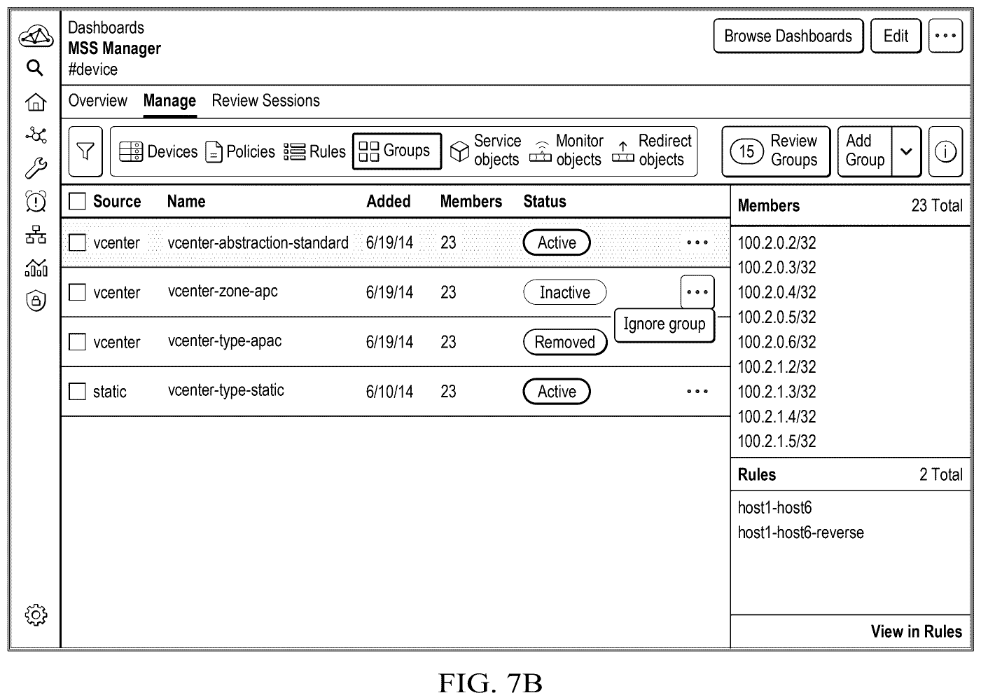

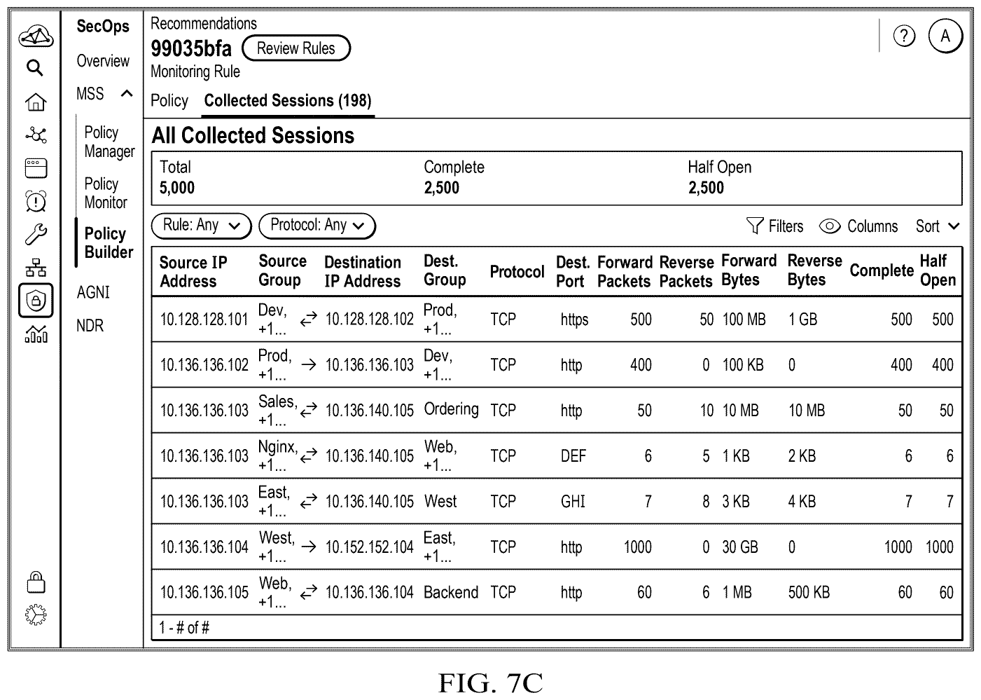

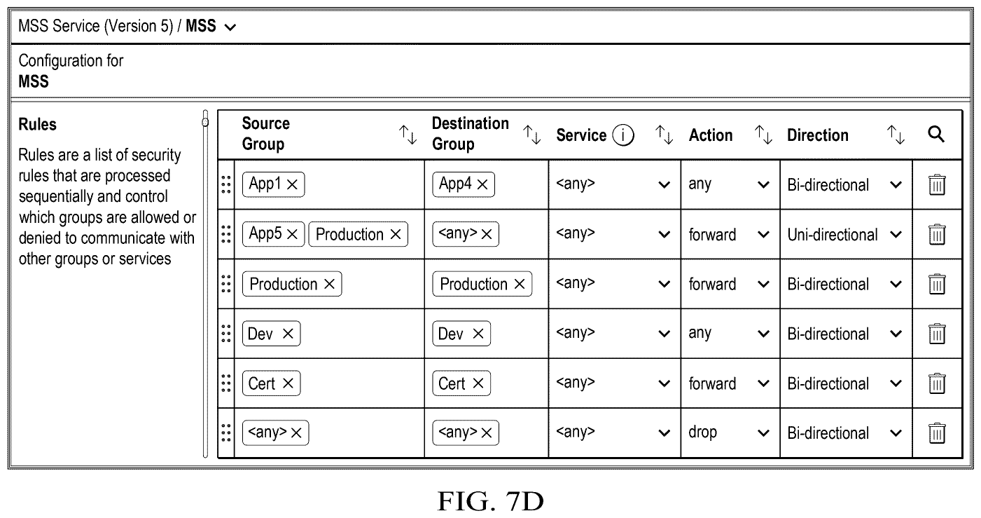

FIGS. 7A and 7B depict embodiments of a group interface that may be utilized to define or review groups that may be defined at central network manager, including security rules associated with those groups. In FIG. 7A, a group named “vcenter-abstraction-standard” has been determined based on a “vcenter” data source and includes the endpoints 100.2.0.2/32, 100.2.0.4/32, 100.2.0.5/32, 100.2.0.6/32, and 100.2.1.2/32. The user may use such an interface to alter the group definitions (e.g., rename, change the group members, define new groups, etc.). In FIG. 7B, the interface displays a list of configured groups. In this example, four groups were created: three dynamic groups derived from vCenter and one statically programmed by a user. The endpoints of the groups are displayed at the top of the sidebar on the right-hand side of the interface, while at the bottom of the interface a list of rules utilizing a selected group is presented.

Returning to FIGS. 5 and 6, central network manager 508 may configure network devices in a network with one or more monitoring rules 506 adapted to configure those network devices to mirror certain traffic to a traffic mapper. Accordingly, during operation of a network, traffic maps 518 may be received (e.g., from traffic mappers) and stored in network data lake 554 utilized by central network manager 508 (STEP 604). Based on these received traffic maps 518 (e.g., from the one or more traffic mappers) session correlator 516 of central network manager 508 may determine a set of (correlated) group based sessions 520 by correlating the sessions of the traffic map 518 with one or more groups 524 or categories 522 (STEP 606). These group based sessions 520 may be sessions defined by one or more (source) groups associated with the source for a session or one or more (destination) groups associated with the destination for the session.

To determine a group session then, session correlator 516 may process each of the sessions of each traffic map 518 to generate one or more corresponding group sessions 520, if needed. Initially then, to process a session from a traffic map 518, the sessions are obtained from the traffic maps 518 and evaluated. Evaluating a session of a traffic map 518 includes determining the source (e.g., the IP address) of that traffic map session and the destination (e.g., the IP address) of that traffic map session, along with a service or protocol of that traffic map session. The determined source (e.g., IP address) may be used to find any group 524 including that source (e.g., IP address) while the determined destination (e.g., IP address) may be used to find any group 524 including that destination (e.g., IP address).

Session correlator 516 can then determine if there are any group based sessions 520 corresponding to that traffic map session already in the set of group based sessions 520. The presence of such a group based session can be determined by evaluating the group based sessions to determine if there are any group based sessions that have a source group and destination group corresponding to the determined source group for the traffic map session, the determined destination group for that traffic map session and have a service or protocol corresponding to the service or protocol determined from the traffic session.

If there is a matching group based session 520, no further action may be taken (or data associated with that matching group based session may be updated). If, however, there is no matching group based session 520 for that traffic map session, one or more group based sessions 520 may be installed (e.g., created) in the set of group based session 520 using the source group associated with the source of the traffic map session, the destination group associated with the destination of the traffic map session, and the service or protocol associated with the traffic map session being evaluated. It will be noted that if there are multiple source groups or multiple destination groups associated with the source or destination as specified in the traffic map session, the group based session 520 may include each of those determined source groups and destination groups as (respectively) source groups and destination groups for that group based session 520, or multiple group based sessions 520 may be installed, where each of the group based session 520 installed may comprise a different permutation of the multiple source groups and destination groups determined for the traffic map session under evaluation. FIG. 7C depicts one embodiment of an interface of a central network manager 508 that may allow a user to access group based sessions 520 and shows examples of data that may be included in group based sessions 520.

Based on these group based sessions 520, a number of group based security rules 504 may be determined by rule determination engine 514 of central network manager 508 (STEP 608). Group based security rules 504 may include a source group, a destination group, a protocol or service, or an action, where the source may be specified as a group 524, an address or prefix, or a value corresponding to any group, and the destination may be specified as a group 524 an address or a prefix, or a value corresponding to any group. The service or protocol may be specifically defined (e.g., as a layer 4 or layer 7 protocol or service) or specified as a value corresponding to any type of service or protocol. The action may be specified as, for example: forward or permit, drop, monitor, drop+monitor (i.e., drop and monitor), or redirect.

In one embodiment, for example, rule determination engine 514 may determine one or more group based security rule recommendations 530 for a user and these group based security rule recommendations 530 presented to a user (e.g., through a rule recommendation interface 512 of the central network manager 508). These group based security rule recommendations 530 may be based on the determined set of group based sessions 520 representing actual or observed flows in the network.

Thus, each group based security rule recommendation 530 may comprise a group based security rule where the action for that rule is determined by the rule determination engine 514 as a recommended action. This recommended action may, for example, be set to permit. Each of the group based security rules for a group based security rule recommendation 530 can be determined based on a corresponding group based session 520, such that the group based security rule specifies (e.g., the same) source as the source group of that corresponding group based session 520, or (e.g. the same) destination as the destination group of that corresponding group based session 520, and the (e.g., same) service or protocol as the service or protocol as that corresponding group based session.

Rule determination engine 514 may also take into account categories 522 when determining group based security rule recommendations 530 for a user. For example, a user may select categories 522 for which group based security rules are to be generated or recommended (e.g., through a rule recommendation interface 512 of central network manager 508). Thus, in one embodiment, group based security rules (or recommendations) may be scoped or otherwise determined based on categories 522. Specifically, one or more categories 522 associated with group based security rule recommendations may be determined (e.g., as selected by a user). When determining a group based security rule based on a group based session 520, the groups 524 associated with the source and destination of the group based session 520 can be evaluated to determine if they are included in the specified category 522. If so, all the groups 524 that are both included in the specified category 522 and associated with the source or destination of the group based session 520 may be included in a group based security rule recommendation 530 for that group based session 520. Alternatively, when generating a group based security rule recommendation 530 for that group based session 520, specific IP addresses associated with traffic map sessions in the traffic map 518 corresponding to that group based session 520 may be utilized as the source or destination for the group based security rule recommendation 530 such the user can evaluate that group based security rule recommendation 530 to determine if that rule recommendation should be accepted (e.g., to determine if that traffic is expected or allowed).

Group based security rule recommendations 530 may be presented to a user (STEP 610) through rule recommendation interface 512. FIG. 7D depicts one example of an interface that may be utilized by central network manager 508 to present group based security rule recommendations to a user or to allow a user to otherwise edit and define group based security rules 504 and shows examples of data that may be included in group based security rules 504, including a source group, a destination group, a service and an action for each group based security rule.

As such, group based security rules may be removed, evaluated, approved, defined, or altered by a user (e.g., through a rule recommendation interface 512 provided by the central network manager 508) to determine group based security rules 504. For example, as discussed above, in an initial group rule definition phase a set of initial group based security rule recommendations may be made to the user such that those initial group based security rule recommendations may be removed, evaluated, approved, or altered by a user.

Once the set of group based security rules 504 is determined (e.g., based on the group based rule recommendations) (STEP 612), these group based security rules may be transmitted to the network devices of the network to be installed (STEP 614) (e.g., by the central network manager 504) such that they can be implemented and enforced at the network devices as those network devices process network traffic. Each of these installed security rules may comprise a source group, a destination group, a protocol or service, and an action such that the action of the group based security rule can be performed in association with a packet matching that security rule. These group based security rules may thus serve to explicitly permit certain traffic on network devices on which they are installed. In some instances, in order to facilitate the installation of these group based security rules on network devices, central network manager 508 may also provide group data 502 to network devices, where that group data may include the definition of groups 524 (e.g., a mapping between group identifiers and IP addresses or prefixes).

In one embodiment, to ensure a zero trust architecture (e.g., and to be able to update group based security rules) a zero trust (last) monitoring rule 506 may also be installed at the network devices by central network manager 508, where that last monitoring rule may specify any source, any destination, any service or protocol and an action of drop, or may specify an action of drop+monitor along with a location of a traffic mapper. Thus, this last rule specifies that all traffic (e.g., from any source to any destination for any protocol or service) will be dropped if it does not meet another security rule installed on the network device, including those that explicitly permit such traffic (and that dropped traffic may also be mirrored to the the traffic mapper). The last rule may ensure that a zero trust architecture is in place but also, additionally, traffic may be mirrored from that network device such that it can be used to monitor traffic and update group based security rules.

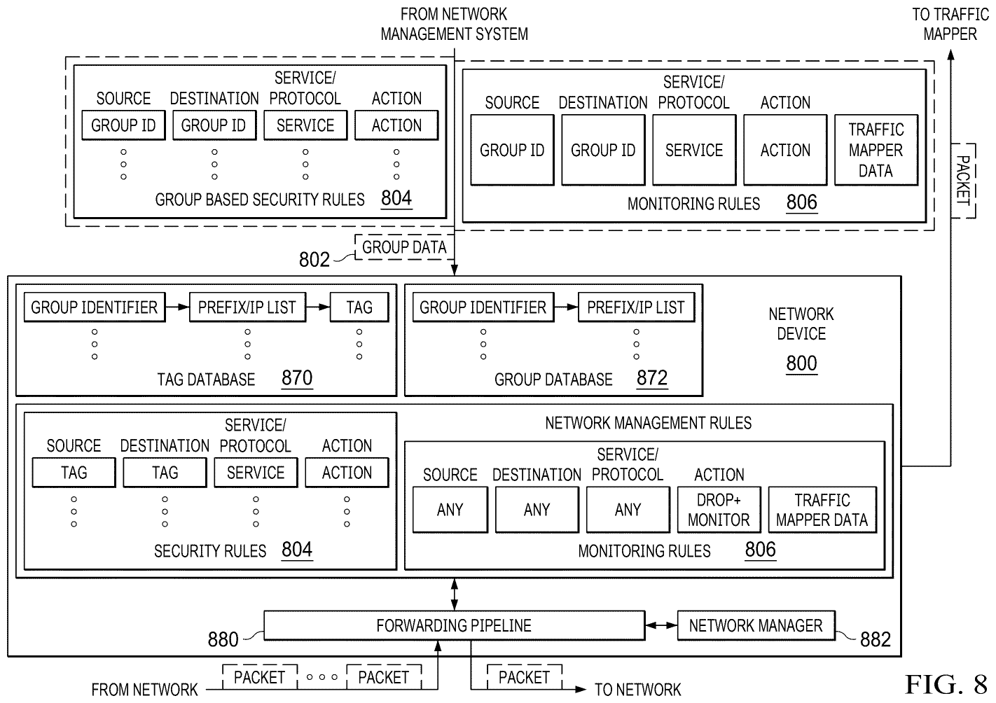

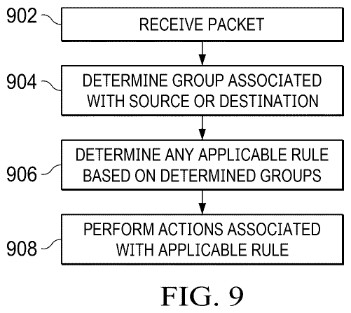

FIGS. 8 and 9 depict one embodiment of a network device and an embodiment of an associated method for operation of a network device for network management according to group based security rules. In this example, network device 800 may be a switch or the like comprising a forwarding pipeline 880 configured to process packets received over the network to perform appropriate actions on those packets. Network manager 882 may be included on network device 800 where the network manager 882 may be adapted to implement multi-tiered network monitoring and enforcement of group based security rules and monitoring rules at network device 800.

Here, network manager 882 may receive monitoring rules 806 from a central network manager. These monitoring rules 806 may be associated with a group or other definition of a type of traffic, including a definition for a source or destination of network traffic, a service or protocol (e.g., SMTP, TCP, HTTP, etc.) and specifying a monitoring action. These monitoring rules 806 may thus be installed at the network device such that these monitoring rules 806 may be applied to traffic being processed by the network device 800 and traffic (packets) meeting these monitoring rules 806 (e.g., having the specified source, destination, and service or protocol as defined in the monitoring rules 806) may be directed to a traffic mapper in the network. Accordingly, a monitoring rule 806 may also define traffic mapper data which may include a location for a traffic mapper.

For example, a monitoring rule 806 specifying that all traffic (e.g., from any source to any destination for any protocol or service) may be mirrored from the network device 800 to the traffic mapper (and may be permitted in the network). As one example, an initial monitoring rule 806 may specify any source, any destination, any service or protocol and an action of monitor. Thus, according to this type of monitoring rule 806 traffic can be processed at the network device 800 (e.g., forwarded, etc.) in accordance with normal operation of the network device 800 while also being mirrored to a traffic mapper. As another example, a last monitoring rule 806 may specify any source, any destination, any service or protocol and an action of drop, or may specify an action of drop+monitor along with a location of a traffic mapper. According to this type of monitoring rule 806 all traffic at the network device 800 can be processed according to this last monitoring rule 806 such that it will be dropped if it isn't expressly permitted while also being mirrored to a traffic mapper.

Network manager 882 may also receive group based security rules 804 from a central network manager and install these group based security rules 804 at the network device 800. In this manner, these group based security rules 804 may be enforced by network device 800 as received packets are processed by forwarding pipeline 880 of the network device. Each of these installed security rules 804 may comprise a source group, a destination group, a protocol or service, and an action such that the action of the group based security rule can be performed in association with a packet matching that security rule 804.

Accordingly, as packets are received at the network device 800 (STEP 902), a source and destination may be determined for the packet and any groups associated with the source or destination for the packet may be determined (STEP 904). Any network management rules (e.g., security rules 804 or monitoring rules 806) associated with the packet can then be determined (STEP 906) and actions associated with those applicable rules (804, 806) taken with respect to that packet (STEP 908).

In one embodiment, installing a group based security rule 804 on network device 800 may include installing the group based security rule 804 in specialized hardware or memory of the network device 800. For example, these group based security rules 804 may be installed in a TCAM on the network device 800. In particular, these group based security rules 804 may be installed as tag based rules where a tag is used to identify a source group and a destination group corresponding to those installed group based security rules 804.

In these embodiments, a tag database 870 may be stored at the network device 800. This tag database may associate a group (e.g., a group identifier for a group) with the set of IP addresses or prefixes corresponding to that group, and a corresponding tag. This tag database 870 may, for example, be stored in relatively higher speed hardware or memory at the network device 800 to accelerate access to such a database. The contents of tag database 870 may be generated by the network device 800 based on a set of group identifiers and set of IP addresses or prefixes associated with each group identifier in a group database 872 (e.g., that may be determined from group data 802 received from a central network manager), or may be otherwise generated. When network manager 882 installs a group based security rule 804 into memory at the network device 800 (e.g., into a TCAM at the network device), the group based security rule 804 may be installed as a tag based rule by using the tags corresponding to the source groups and destination groups for that group based security rule 804 as the source and destination values for the installed group based security rule in the memory.

Thus, when a packet is received at network device 800, the source IP and destination IP address (or prefix) associated with the received packet may be determined, along with the service or protocol corresponding to the received packet. The source IP determined from the packet can then be used to look up any associated groups with that source IP in tag database 870 and the corresponding tags for each of those groups determined. Similarly, the destination IP determined from the packet can be used to look up any associated groups with that destination IP in tag database 870 and the corresponding tags for each of those groups determined. The determined tags for the source groups and the determined tags for the destination groups can then be used (e.g., along with the service or protocol) to perform a match for installed tag based group security rules 804. Such a match may, for example, comprise a tag based lookup in a TCAM in which the group based security rules are installed. In this manner, these group based security rules 804 may be matched and applied substantially in real-time (e.g., as wire speed) as network device 800 processes network traffic.

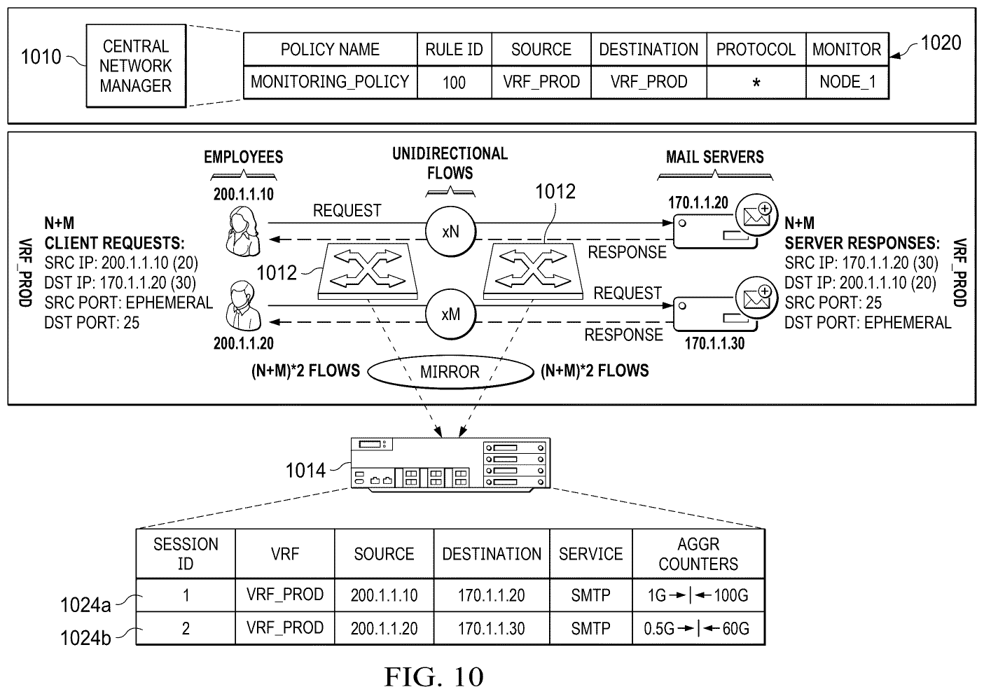

It may here be useful to an understanding of embodiments to discuss specific examples. FIG. 10 depicts one example of mirroring packets to a traffic mapper based on a monitoring rule. In this example, central network manager 1010 has configured network devices (e.g., switches) 1012 with monitoring rule 1020 specifying a source (e.g., group) a destination (e.g., group) and the location of a traffic mapper 1014 referred to as “node 1”. As depicted, two employees (e.g., members of an employee group and members of the VRF_Prod group) may connect to two different email servers (e.g., part of a mail servers group and members of the VRF_Prod group) repeatedly over a period of time. For example, they will start a request from an ephemeral source layer 4 port toward designated destination port 25, and each mail server will respond from port 25 to the endpoint's ephemeral port. In this example, over time client 200.1.1.10 will have sent N requests and will have received N responses from an email server 170.1.1.20 (for a total of N sessions). Similarly, client 200.1.1.20 will have sent M requests and will have received M responses from the other email server 170.1.1.30 (for a total of M sessions).

Since each email session is bidirectional, the total number of observed unidirectional flows is (N+M)*2. All the packets of each of these sessions ((N+M)*2 flows) are mirrored by switches 1012 based on monitoring rule 1020 configured at those switches 1012, so that they can be conveyed to the (local or remote) traffic mapper 1014 (Node 1) for analysis and summarization. In this email server example, the N sessions are summarized into a single session 1024a and the M sessions are summarized into a single session 1024b, where each of the I sessions 1024a, 1024b is expressed as a common tuple defined as (VRF, source address, destination address, and service). The counters of the aggregated (e.g., M and N) sessions are also aggregated to represent the total amount of associated traffic in each session 1024. In this manner, the scalability of a traffic map produced from such sessions may be greatly improved.

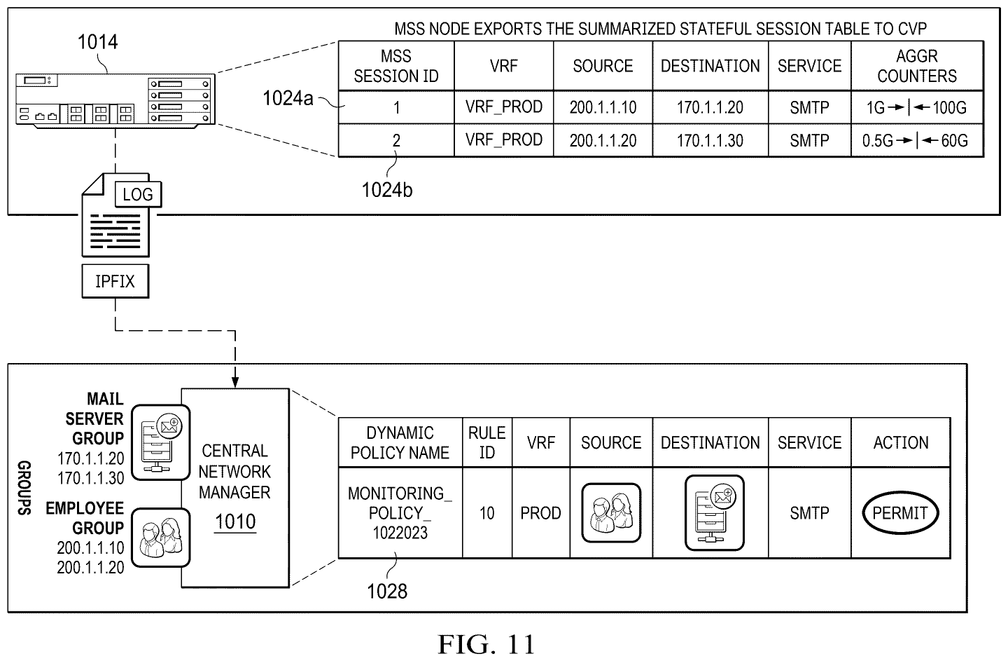

Moving now to FIG. 11, traffic mapper 1014 exports these summarized sessions 1024 to central network manager 1010 (e.g., using IPFIX or the like) as a traffic map. Central network manager 1010 may then determine a group based session based on these traffic map sessions 1024 and generate a group based security rule recommendation 1028 based on the determined group based session. Specifically, central network manager 1010 may first process traffic map session 1024a and determine that source IP address 200.1.1.10 of traffic map session 1024a is a member of the employee group defined at the central network manager 1010 while destination IP address 170.1.1.20 of traffic map session 1024a is a member of the mail server group defined at the central network manager 1010. Moreover, central network manager 1010 determines that the service for this session 1024a is SMTP. The central network manager 1010 can then create a group based session comprising a source including the employee group, a destination including the mail server group, and a protocol or service specifying SMTP.

When subsequently processing traffic map session 1024b, central network manager 1010 may determine that source IP address 200.1.1.20 of traffic map session 1024b is a member of the employee group defined at the central network manager 1010, destination IP address 170.1.1.30 of traffic map session 1024b is a member of the mail server group defined at the central network manager 1010 and the service for this session 1024b is SMTP. Central network manager 1010 can thus determine that there is already a group based session comprising a source including the employee group, a destination including the mail server group, and a protocol or service specifying SMTP. As such, central network manager 1010 may not create any additional group based session at central network manager 1010 based on session 1024b. As can be seen then, a single group based session may be used to consolidate (e.g., summarize) multiple individual sessions 1024 in a traffic map. The central network manager 1010 can thus generate a group based security rule recommendation 1028 based on the determined group based session summarizing multiple sessions 1024 observed in the network.

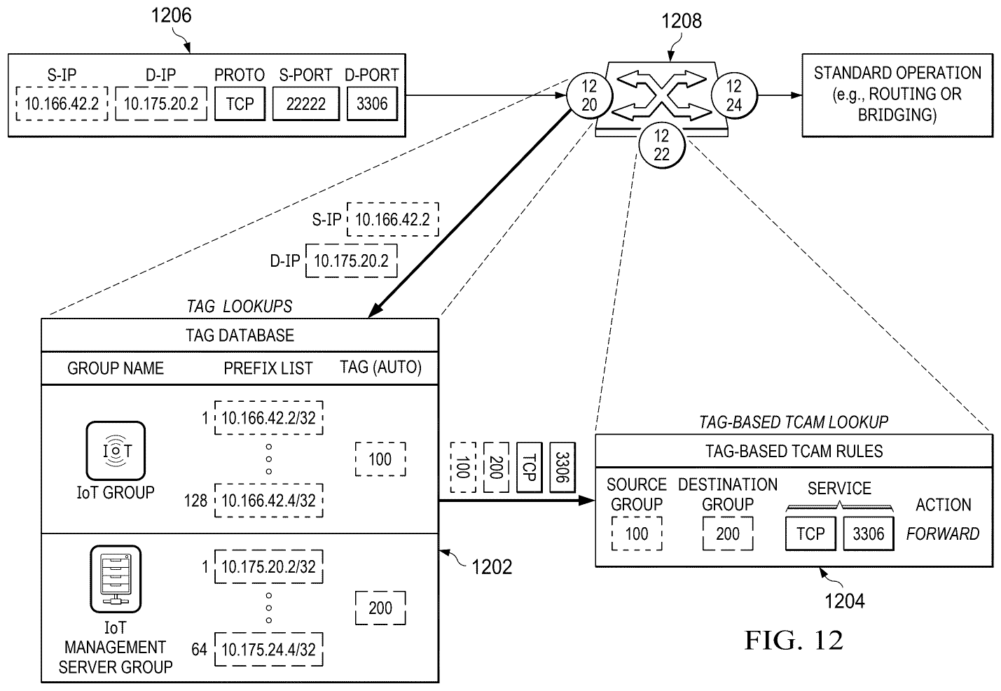

Referring finally to FIG. 12, an example of how network devices adapted for embodiments of network management as described herein may leverage groups (e.g., of endpoints) to provide wire-speed rule enforcement is depicted. In this example, a network manager in the control plane of a network device 1208 may translate group definitions mapping endpoints (e.g., prefix) to groups into internal tags. These tags and a mapping of these tags to their associated endpoints may be stored in a (e.g., hardware) tag database 1202 (e.g., any suitable data structure, such as a table or the like) at the network device 1208. These tags may be internal tags that are locally significant to each individual network device 1208 and may be completely independent from the network (e.g., control and data plane). As a result, the utilization of such tags may be interoperable with any standard network topology and network protocol (e.g., in an infrastructure that incorporates network devices of different types, architecture, from different manufacturers, etc.). The tags stored in the tag database 1202 are utilized to program TCAM rules 1204 at the network device 1208 such that these tags summarize and replace sets of IP addresses or prefixes as a source or destination in TCAM rules 1204.

When packets 1206 enter network device 1208, a simultaneous source and destination IP address lookup operation may occur in tag database 1202 to derive the tags corresponding to the IP addresses of the packet (STEP 1220). Then the tags (e.g., along with the rest of the packet fields such as the service or protocol) are used to perform a lookup operation in the TCAM where rules 1204 are programmed using tags as sources and destinations (STEP 1222). Once the network device 1208 applies any security action (e.g., drop or forward) identified in a matching TCAM rule 1204, normal operations (e.g., routing or bridging) may occur in the network device 1208 (STEP 1224).

Thus, according to one embodiment the entire process of lookup and enforcement may occur substantially at wire speed without any latency or bandwidth penalty, and before normal bridging and routing operations of the device. Moreover, tag generation may be optimized at the network device to maximize rule compression in the TCAM and enable much greater rule scalability in hardware. As these tags may only be locally significant (e.g., within that network device) they may be data plane and control plane agnostic, enabling the graceful insertion and use of embodiments in almost any network and promote interoperability with other network components. Additionally, these embodiments may support hybrid group based security rules with a mix of groups and IP addresses or prefixes for the source or destination of rules, along with multiple actions for those rules.

It will be understood that while specific embodiments have been presented herein, these embodiments are merely illustrative, and not restrictive. Rather, the description is intended to describe illustrative embodiments, features, and functions in order to provide an understanding of the embodiments without limiting the disclosure to any particularly described embodiment, feature, or function, including any such embodiment, feature, or function described. While specific embodiments of, and examples for, the embodiments are described herein for illustrative purposes only, various equivalent modifications are possible within the spirit and scope of the invention, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments of the invention will be employed without a corresponding use of other features, and features described with respect to one embodiment may be combined with features of other embodiments without departing from the scope and spirit of the disclosure as set forth.

What is claimed is:

1. A method for network management, comprising:
determining a set of groups in a network, each of the set of groups comprising one or more endpoints in the network;
receiving at a traffic mapper in a network, packets received at network infrastructure devices comprising the network and mirrored to the traffic mapper;
determining, at the traffic mapper, a traffic map comprising a set of sessions observed in the network, wherein each of the set of sessions includes a source endpoint and a destination endpoint in the network;
determining a set of group based sessions based on the set of sessions in the traffic map and the set of groups, each group based session including a source group determined from the set of groups or a destination group determined from the set of groups and wherein each group based session summarizes each of the set of sessions of the traffic map observed in the network between one or more members of the source group of that group based session and one or more members of the destination group of that group based session;
determining a set of group based security rules based on the set of group based sessions, wherein each of the group based security rules is based on a corresponding group based session of the set of group based sessions and includes the source group of the corresponding group based session, the destination group of the corresponding group based session, and an action; and
transmitting the set of group based security rules to the network infrastructure devices for installation to enforce the set of group based security rules at the network infrastructure devices.

2. The method of claim 1, further comprising presenting the set of group based security rules to a user as a set of rule recommendations.

3. The method of claim 2, wherein the action of the set of group based security rules comprises a permit action.

4. The method of claim 1, wherein each of the set of sessions, set of group based sessions, and group based security rules is associated with a service such that each group based session summarizes each of the set of sessions occurring between one or more members of the source group and one or more members of the destination group according to the service.

5. The method of claim 4, wherein mirrored packets are determined based on a monitoring rule installed at the network infrastructure devices.

6. The method of claim 5, wherein the monitoring rule specifies any source and any destination and any service.

7. The method of claim 6, wherein the monitoring rule specifies a location of the traffic mapper in the network.

8. The method of claim 5, wherein the monitoring rule is a last monitoring rule specifying an action of drop and monitor.

9. The method of claim 5, wherein the monitoring rule is an initial monitoring rule specifying an action of monitor.

10. The method of claim 1, wherein the set of group based security rules are installed in a ternary content addressable memory (TCAM) at the network infrastructure device.

11. The method of claim 10, wherein each of the set of group based security rules is installed in the TCAM as a corresponding tag based rules, each tag based rule comprising a source tag representing the source group of the corresponding group based security rule or a destination tag representing the destination group of the corresponding group based security rule.

12. A network management system, comprising:
a traffic mapper, comprising a processor, wherein the traffic mapper is adapted to:
receive packets mirrored to the traffic mapper from network infrastructure devices comprising a network; and
determine a traffic map comprising a set of sessions observed in the network, wherein each of the set of sessions includes a source endpoint, a destination endpoint in the network and a service; and
a central network manager, comprising:
a data store including a definition of a set of groups in a network, each of the set of groups comprising one or more endpoints in the network;
determining a set of group based sessions based on the set of sessions in the traffic map and the set of groups, each group based session including a source group determined from the set of groups or a destination group determined from the set of groups and wherein each group based session summarizes each of the set of sessions of the traffic map observed in the network between one or more members of the source group of that group based session and one or more members of the destination group of that group based session according to the service;
determining a set of group based security rules based on the set of group based sessions, wherein each of the first group based security rules is based on a corresponding group based session of the set of group based session and includes the source group of the corresponding group based session, the destination group of the corresponding group based session, and an action;
presenting the set of group based security rules as rule recommendations to a user; and
installing the set of group based security rules on the network infrastructure devices to enforce the set of group based security rules at the network infrastructure devices.

13. The network management system of claim 12, wherein the action comprises a permit action.

14. The network management system of claim 12, wherein the central network manager is adapted to install a monitoring rule at the network infrastructure devices, wherein packets are mirrored to the traffic mapper based on the monitoring rule.

15. The network management system of claim 14, wherein the monitoring rule specifies any source and any destination and any service.

16. The network management system of claim 14, wherein the monitoring rule specifies a location of the traffic mapper in the network.

17. The network management system of claim 14, wherein the monitoring rule is a last monitoring rule specifying an action of drop and monitor or an initial monitoring rule specifying an action of monitor.

18. A network management system, comprising:
a network infrastructure device in a network, comprising a processor, wherein the network infrastructure device is configured with a monitoring rule specifying any source, any destination and any service and the network infrastructure device is adapted to mirror packets matching the monitoring rule to a traffic mapper;
a traffic mapper, comprising a processor, wherein the traffic mapper is adapted to:
receive packets mirrored to the traffic mapper from the network infrastructure devices; and
determine a traffic map comprising a set of sessions observed in the network, wherein each of the set of sessions includes a source endpoint, a destination endpoint in the network and a service; and
a central network manager, comprising:
a data store including a definition of a set of groups in the network, each of the set of groups comprising one or more endpoints in the network, and a processor adapted to;
determine a set of group based sessions based on the set of sessions in the traffic map and the set of groups, each group based session including a source group determined from the set of groups or a destination group determined from the set of groups and wherein each group based session summarizes each of the set of sessions of the traffic map observed in the network between one or more members of the source group of that group based session and one or more members of the destination group of that group based session according the service;
determine a set of group based security rules based on the set of group based sessions, wherein each of the first group based security rules is based on a corresponding group based session of the set of group based session and includes the source group of the corresponding group based session, the destination group of the corresponding group based session, and an action; and
install the set of group based security rules on the network infrastructure devices to enforce the set of group based security rules at the network infrastructure devices.

19. The network management system of claim 18, wherein the network infrastructure device comprises a ternary content addressable memory (TCAM) and the network infrastructure device is adapted to install the set of group based rules in the TCAM.

20. The network management system of claim 19, wherein the network infrastructure device is adapted to install each of the set of group based rules in the TCAM as a corresponding tag based rules using tags determined based on the definition of the set of groups.
